(19) United States
(12) Patent Application Publication
(10) Pub. No.: US 2010/0023613 A1
(43) Pub. Date: Jan. 28, 2010

(54) Managing Pluggable Modules Of A Network Element

(75) Inventors: Ke Gao, Plano, TX (US); Catherine Yuan, Plano, TX (US); Jeffrey G. Huettner, Fairview, TX (US); Janice E. Jackson, Dallas, TX (US)

Correspondence Address: BAKER BOTTS L.L.P., 2001 ROSS AVENUE, SUITE 600, DALLAS, TX, 75201-2980, US

(73) Assignee: Fujitsu Network Communications, Inc., Richardson, TX (US)

(21) Appl. No.: 11/938,447

(22) Filed: Nov. 12, 2007

(51) Int. Cl. G06F 15/173

(52) U.S. Cl. 709/224

(57) ABSTRACT

Managing pluggable modules of a network element includes receiving an approved pluggable module list for the network element. A pluggable module is received at the network element, and a component identifier of the pluggable module is determined. If the component identifier is on the approved pluggable module list, the pluggable module is approved for operation with the network element. If the component identifier is not on the approved pluggable module list, the pluggable module is rejected for operation with the network element.

### TECHNICAL FIELD

This invention relates generally to the field of communication networks and more specifically to managing pluggable modules of a network element.

### BACKGROUND

A vendor of a network element may manage the pluggable modules that can be used with the network element. In one approach, a vendor maintains little or no control over the pluggable modules, and any of a variety of modules can be used with the network element. In another approach, a vendor maintains tight control over the pluggable modules, and only certain modules, such as those sold by the vendor, can be used with the network element.

### SUMMARY OF THE DISCLOSURE

In accordance with the present invention, disadvantages and problems associated with previous techniques for managing pluggable modules may be reduced or eliminated.

According to one embodiment of the present invention, managing pluggable modules of a network element includes receiving an approved pluggable module list for the network element. A pluggable module is received at the network element, and a component identifier of the pluggable module is determined. If the component identifier is on the approved pluggable module list, the pluggable module is approved for operation with the network element. If the component identifier is not on the approved pluggable module list, the pluggable module is rejected for operation with the network element.

Certain embodiments of the invention may provide one or more technical advantages. A technical advantage of one embodiment may be that a network element stores a list of approved pluggable modules that are allowed to operate with the network element. A vendor provides the list. Another technical advantage of one embodiment may be that the approved pluggable module list may be encrypted before being sent to the network element. Another technical advantage of one embodiment may be that an alarm event is triggered if a pluggable module that is not on the approved pluggable module list is plugged into the network element.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a system for managing pluggable modules;

FIG. 2 illustrates one embodiment of a network element that may be used with the system of FIG. 1;

FIG. 3 illustrates one embodiment of a method for providing an approved pluggable module list for managing pluggable modules in a network element; and

FIG. 4 illustrates one embodiment of a method for approving a pluggable module in a network element.

### DETAILED DESCRIPTION OF THE DRAWINGS

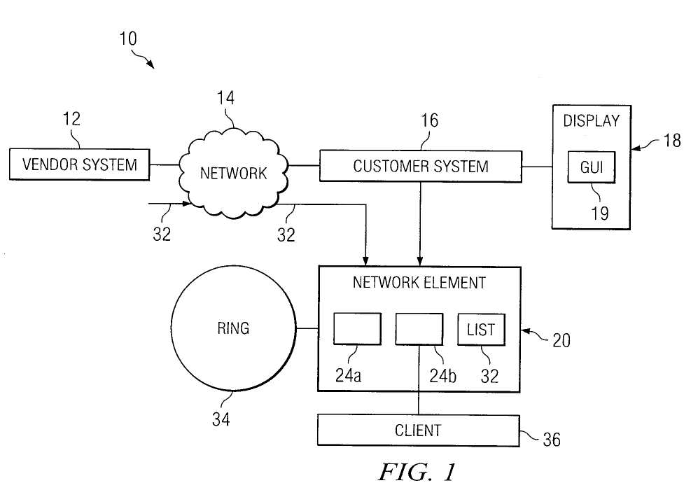

Embodiments of the present invention and its advantages are best understood by referring to FIGS. 1 through 4 of the drawings, like numerals being used for like and corresponding parts of the various drawings.

FIG. 1 illustrates one embodiment of a system 10 for managing pluggable modules. According to the illustrated embodiment, system 10 includes a vendor system 12, a customer system 16, a display 18, and a network element 20. Vendor system 12 is coupled to customer system 16 via a network 14. Customer system 16 is coupled to display 18 and network element 20.

In the embodiment, vendor system 12 provides an approved pluggable module list 32 that designates pluggable modules that are approved for operation with network element 20. Network element 20 receives and stores list 32. If a pluggable module received by network element 20 is on list 32, the component is allowed to operate with network element 20. If the pluggable module is not on list 32, the component is not allowed to operate with network element 20.

Vendor system 12 includes a computer system associated with a vendor of network element 20. In various embodiments, the vendor may manufacture, sell, lease, or otherwise provide network element 20 to the customer. Vendor system 12 generates an approved pluggable module list 32 that designates pluggable modules that are approved for use with network element 20. The modules may be designated by component identifiers. In one embodiment, approved pluggable module list 32 may be generated and/or modified by vendor system 12 or with authorization from vendor system 12 or the vendor. For example, list 32 may be unmodifiable by customer system 16, that is, customer system 16 is not able to modify list 32. Vendor system 12 stores list 32 in a file that may be sent to customer system 16 via network 14.

Network 14 includes a communication network that provides communication between vendor system 12 and customer system 16. Network 14 may be at least a portion of any local area network (LAN), wireless local area network (WLAN), metropolitan area network (MAN), wide area network (WAN), virtual private network (VPN), and/or any other system that facilitates communication in a network environment. Network 14 may include an Internet Protocol (IP) network that implements a User Datagram Protocol/Internet Protocol (UDP/IP) connection and use a Transmission Control Protocol/IP (TCP/IP) communication language protocol. Network 14, however, may implement any other suitable communication protocol for transmitting and receiving data packets within system 10.

Customer system 16 includes a computer system associated with a customer. In various embodiments, the customer obtains network element 20 from the vendor, for example, by purchasing or leasing network element 20 from the vendor. Customer system 16 allows the customer to control and configure various operational aspects of network element 20. In accordance with an embodiment, customer system 16 sends the file of approved pluggable module list 32 to network element 20.

Display 18 is coupled to the customer system 16 and displays a graphical user interface (GUI) 19. GUI 19 allows a user to input information to and receive information from customer system 16 and network element 20. In various embodiments, GUI 19 displays the list of approved pluggable modules. In some embodiments, the user may or may not be allowed to add a pluggable module to, delete a pluggable module from, or otherwise modify approved pluggable module list 32.

Network element 20 may represent any suitable device operable to route signals to or from a communication system. Examples of network element 20 include a dense wavelength division multiplexer (DWDM), access gateway, endpoint, softswitch server, trunk gateway, and/or other device operable to route packets to or from a communication network. In one embodiment, network element 20 may perform operations to communicate signals between an optical network and a client 36. Examples of operations include signal routing, signal aggregation and/or separation, analog-to-digital and/or digital-to-analog conversion, encoding and/or decoding, and/or optical-to-electrical and/or electrical-to-optical signal transformation.

Network element 20 includes one or more pluggable module interfaces operable to receive one or more pluggable modules 24a, 24b. Pluggable modules 24a, 24b may refer to logic that can be coupled to network element 20 to communicate signals between network element 20 and client 36. Pluggable modules 24a, 24b may perform any suitable operation for network element 20, for example, Ethernet interfacing, optical multiplexing, and/or optical cross-connection operations. In various embodiments, pluggable modules 24a, 24b may be pluggable optical modules, such as small factor pluggables (SFPs) and/or 10-Gbps small form factor pluggables (XFPs).

A device of system 10 may include logic, an interface, memory, other component, or any suitable combination of the preceding. Logic includes hardware, software, other logic, or any suitable combination of the preceding. Logic may be encoded in one or more tangible computer-readable media. Certain logic may manage the operation of a device, and may comprise, for example, a processor that executes instructions and manipulates data to perform operations.

An interface receives input, sends output, performs suitable processing of the input or output or both, or any combination of the preceding, and may comprise one or more ports, conversion software, or both. Memory stores and facilitates retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Modifications, additions, or omissions may be made to system 10 without departing from the scope of the invention. The components of system 10 may be integrated or separated according to particular needs. Moreover, the operations of system 10 may be performed by more, fewer, or other devices. Additionally, operations of system 10 may be performed using any suitable logic. As used in this document, “each” refers to each member of a set or each member of a subset of a set.

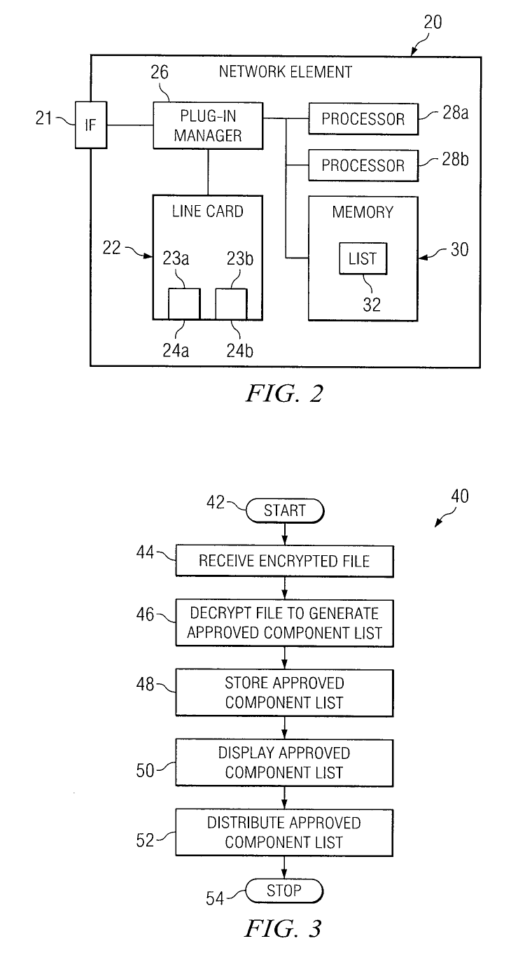

FIG. 2 illustrates one embodiment of network element 20 that may be used with system 10 of FIG. 1. According to the illustrated embodiment, network element 20 includes an interface 21, a line card 22, one or more pluggable modules 24a, 24b, a pluggable manager 26, one or more processors 28a, 28b, and a memory 30.

Line card 22 may represent a modular electronic circuit on a printed circuit board. In various embodiments, line card 22 operates as an interface between network element 20 and client 36. Examples of line card 22 include transponders, muxponders, and/or flexponders.

Network element 20 or line card 22 includes one or more pluggable module interfaces 23a, 23b. A pluggable module interface 23 is configured to receive a pluggable module 24. For example, pluggable module interface 23 may have connections appropriate to communicate signals to and from pluggable module 24. Moreover, pluggable module interface 23 may be shaped to receive pluggable module 24.

Pluggable modules 24a, 24b communicate signals between network element 20 and client 36. In the illustrated embodiment, pluggable modules 24a, 24b are adapted to be plugged into line card 22. In still other embodiments, pluggable modules 24a, 24b are adapted to be plugged into network element 20 without line card 22.

Pluggable manager 26 manages pluggable modules 24a, 24b. In one embodiment, pluggable manager 26 receives a file that includes approved pluggable module list 32. If the file is encrypted, pluggable manager 26 decrypts the file to generate list 32. Pluggable manager 26 stores list 32 in memory 30 and distributes list 32 to processors 28a, 26b. In at least one embodiment, the pluggable manager 26 allows a user to view list 32 using GUI 19.

In one embodiment, if pluggable module 24a, 24b is not on approved pluggable module list 32, pluggable manager 26 triggers an alarm event and stores alarm event information in memory 30. The alarm event information may include any suitable information about the plug-in event, such as a time stamp indicating the time when the unapproved pluggable module 24a, 24b was inserted into network element 20, and/or a part number and/or a manufacturer identifier of the unapproved pluggable module 24a, 24b. In one embodiment, the alarm event information may be sent to vendor system 12.

Processors 28a, 28b execute logic to control operations of the network element 20. Processors 28a, 28b may include one or more microprocessors, application specific integrated circuits (ASICs), and/or other suitable processor. In one embodiment, pluggable manager 26 allows processors 28a, 28b to operate with a particular pluggable module 24a, 24b if the pluggable module 24a, 24b is on list 32. Pluggable manager 26 prevents processors 28a, 28b from operating with a pluggable module 24a, 24b if the pluggable module 24a, 24b is not on list 32.

In at least one embodiment, memory 30 is a volatile or non-volatile memory. In a particular embodiment, memory 30 stores approved pluggable module list 32 in a database.

Modifications, additions, or omissions may be made to network element 20 without departing from the scope of the invention. The components of network element 20 may be integrated or separated according to particular needs. Moreover, the operations of network element 20 may be performed by more, fewer, or other devices. Additionally, operations of network element 20 may be performed using any suitable logic.

FIG. 3 illustrates one embodiment of a method 40 for providing an approved pluggable module list 32 for managing pluggable modules in network element 20. According to one embodiment, the method may be performed by network element 20.

The method begins at step 42. In step 44, pluggable manager 26 of network element 20 receives an encrypted file through an interface. In one embodiment, customer system 16 may receive the encrypted file from vendor system 12 via network 14 or computer readable media. Network element 20 may then download the encrypted file from customer system 16.

In step 46, pluggable manager 26 decrypts the encrypted file to generate approved pluggable module list 32. Approved pluggable module list 32 designates pluggable modules 24a, 24b approved for use with network element 20.

In step 48, pluggable manager 26 stores approved pluggable module list 32 in memory 30. In step 50, display of approved pluggable module list 32 by GUI 19 may be initiated to allow a user to view list 32. In step 52, approved pluggable module list 32 is distributed to processors 28a, 28b. The method ends in step 54.

Modifications, additions, or omissions may be made to the method without departing from the scope of the invention. The method may include more, fewer, or other steps. Additionally, steps may be performed in any suitable order without departing from the scope of the invention.

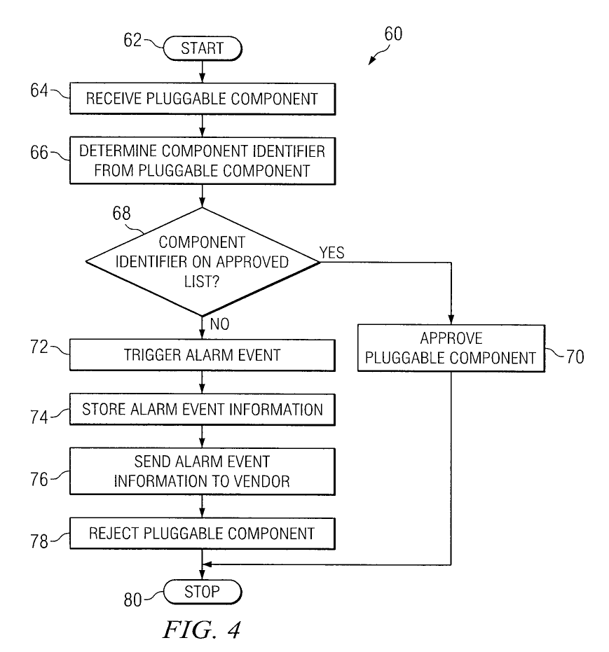

FIG. 4 illustrates one embodiment of a method 60 for approving a pluggable module 24a, 24b in network element 20. In step 62, the method 60 begins. In step 64, the network element 20 receives pluggable module 24a, 24b through a pluggable module interface. Pluggable module 24a, 24b may be inserted into line card 22 of network element 20. In step 66, pluggable manager 26 determines a component identifier of the received pluggable module 24a, 24b. Pluggable manager 26 may determine the component identifier by reading the component identifier from a memory of pluggable module 24a, 24b.

In step 68, pluggable manager 26 determines whether the component identifier is on approved pluggable module list 32. If the component identifier is on list 32, pluggable module 24a, 24b is approved for operation with one or more processors 28a, 28b of network element 20 in step 70.

If the component identifier is not on list 32, pluggable manager 26 triggers an alarm event in step 72. In step 74, alarm event information is stored in memory 30. In step 76, the alarm event information may be sent to and stored by the vendor system 12. In step 78, the pluggable module 24a, 24b is rejected for operation with the network element 20. In step 80, the method 60 ends.

In various embodiments, if one or more of processors 28a, 28b experience a restart, the pluggable manager 26 will automatically reload the approved pluggable module list 32 into the processors 28a, 28b from the memory 30.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method comprising:
receiving an approved pluggable module list for a network element;
receiving a pluggable module at the network element;
determining a component identifier of the pluggable module;
determining if the component identifier is on the approved pluggable module list;
approving the pluggable module for operation with the network element if the component identifier is on the approved pluggable module list; and
rejecting the pluggable module for operation with the network element if the component identifier is not on the approved pluggable module list.

2. The method of claim 1, further comprising:
triggering an alarm event if the component identifier is not on the approved pluggable module list.

3. The method of claim 1, further comprising:
triggering an alarm event if the component identifier is not on the approved pluggable module list; and
storing alarm information describing the alarm event.

4. The method of claim 1, further comprising:
triggering an alarm event if the component identifier is not on the approved pluggable module list; and
sending alarm information describing the alarm event to a vendor.

5. The method of claim 1, wherein receiving the approved pluggable module list further comprises:
receiving an encrypted file;
decrypting the encrypted file to generate the approved pluggable module list.

6. The method of claim 1, further comprising:
distributing the approved pluggable module list to at least one processor of the network element.

7. The method of claim 1, determining the component identifier of the pluggable module further comprising:
determining the component identifier by reading the component identifier from a memory of pluggable module.

8. The method of claim 1, further comprising:
initiating display of the approved pluggable module list.

9. The method of claim 1, wherein a vendor of the network element provides the approved pluggable module list.

10. The method of claim 1, further comprising:
storing the approved pluggable module list in non-volatile memory.

11. The method of claim 1, the approved pluggable module list unmodifiable by a customer system.

12. An apparatus comprising:
a plurality of interfaces operable to:
receive an approved pluggable module list for a network element; and
receive a pluggable module at the network element; and
logic encoded in one or more tangible computer-readable storage media and operable to:
determine a component identifier of the pluggable module;
determine if the component identifier is on the approved pluggable module list;
approve the pluggable module for operation with the network element if the component identifier is on the approved pluggable module list; and
reject the pluggable module for operation with the network element if the component identifier is not on the approved pluggable module list.

13. The apparatus of claim 12, the logic further operable to:
trigger an alarm event if the component identifier is not on the approved pluggable module list.

14. The apparatus of claim 12, the logic further operable to:
trigger an alarm event if the component identifier is not on the approved pluggable module list; and
store alarm information describing the alarm event.

15. The apparatus of claim 12, the logic further operable to:
trigger an alarm event if the component identifier is not on the approved pluggable module list; and
send alarm information describing the alarm event to a vendor.

16. The apparatus of claim 12:
the plurality of interfaces further operable to receive the approved pluggable module list by:
receiving an encrypted file; and
the logic further operable to:
decrypt the encrypted file to generate the approved pluggable module list.

17. The apparatus of claim 12, the logic further operable to:
distribute the approved pluggable module list to at least one processor of the network element.

18. The apparatus of claim 12, the logic further operable to determine the component identifier of the pluggable module by:
determining the component identifier by reading the component identifier from a memory of pluggable module.

19. The apparatus of claim 12, the logic further operable to:
initiate display of the approved pluggable module list.

20. The apparatus of claim 12, wherein a vendor of the network element provides the approved pluggable module list.

21. The apparatus of claim 12, the approved pluggable module list unmodifiable by the apparatus.

22. A system comprising:
means for receiving an approved pluggable module list for a network element;
means for receiving a pluggable module at the network element;
means for determining a component identifier of the pluggable module;
means for determining if the component identifier is on the approved pluggable module list;
means for approving the pluggable module for operation with the network element if the component identifier is on the approved pluggable module list; and
means for rejecting the pluggable module for operation with the network element if the component identifier is not on the approved pluggable module list.
